(19) United States
(12) Patent Application Publication
(10) Pub. No.: US 2019/0066549 A1
(43) Pub. Date: Feb. 28, 2019

(54) MATERIALS AND METHODS FOR MANUFACTURING BOLLARDS

(71) Applicant: Serigraph Inc., West Bend, WI (US)

(72) Inventors: Daniel Richard Sackett, West Bend, WI (US); Joan Leslie Kelly, Slinger, WI (US)

(73) Assignee: Serigraph Inc., West Bend, WI (US)

(21) Appl. No.: 16/114,707

(22) Filed: Aug. 28, 2018

Related U.S. Application Data
(60) Provisional application No. 62/550,978, filed on Aug. 28, 2017.

(51) Int. Cl. G09F 15/00; E01F 9/65

(52) U.S. Cl. CPC G09F 15/0018; E01F 9/65; G09F 23/00; G09F 15/0062; G09F 15/0075; G09F 15/0037

(57) ABSTRACT

Bollards and methods of making bollards having a material with a thickness of less than 0.125″. The material has a fixed end, a floating end opposite the fixed end, and a fixation region defined therebetween. The bollard further includes a locking system for retaining the floating end of the material adjacent to the fixation region. The bollard is configured to be assembled by folding the material such that the floating end is adjacent to the fixation region and engaging the locking system to retain the floating end adjacent to the fixation region.

### CROSS REFERENCE TO RELATED APPLICATION

This application claims the benefit of U.S. Provisional Patent Application No. 62/550,978 filed Aug. 28, 2017, which is incorporated herein by reference in its entirety.

### FIELD

The field of the invention relates to bollards, otherwise referred to as crash pole wraps. In particular, the present invention relates to bollards made of a relatively thin gauge material that allows for lithographic printing and higher quality graphics on the surface of the bollard.

### BACKGROUND

Current bollards are made from a relatively thick material, such as a 4 mm or ⅛″ corrugated plastic sheets (e.g. Coroplast™ brand), which is screen printed or digitally printed and may be either die cut, or cut using a computer numerical control (CNC) router. Corrugated plastic sheets are used for their weatherability and durability. These corrugated plastic sheets are similar to corrugated card board, but are made of plastic that has large air cells in-between the front and back surfaces formed by flutes.

### SUMMARY

One embodiment of the present disclosure generally relates to a bollard having a material with a thickness of less than 0.125″, where the material has a fixed end, a floating end opposite the fixed end, and a fixation region defined therebetween. The bollard further includes a locking system for retaining the floating end of the material adjacent to the fixation region. The bollard is configured to be assembled by folding the material such that the floating end is adjacent to the fixation region and engaging the locking system to retain the floating end adjacent to the fixation region.

Another embodiment generally relates to a method for making a bollard that includes obtaining a material having a thickness of less than 0.125″. The material has a fixed end, a floating end opposite the fixed end, and a fixation region defined therebetween. The material is non-corrugated. The method further includes incorporating a locking system for retaining the floating end of the material adjacent to the fixation region. The bollard is configured to be assembled by folding the material such that the floating end is adjacent to the fixation region and engaging the locking system to retain the floating end adjacent to the fixation region.

Various other features, objects and advantages of the disclosure will be made apparent from the following description taken together with the drawings.

### BRIEF DESCRIPTION OF THE DRAWINGS

The drawings illustrate embodiments for carrying out the disclosure. The same numbers are used throughout the drawings to reference like features and like components. In the drawings:

FIG. 1 is a side view of the outside of a bollard presently known in the art in disassembled form;

FIG. 2 is a side view of the inside of the bollard of FIG. 2, shown partially folded;

FIGS. 3 and 4 are top plan and side isometric views of the bollard of FIG. 1 in assembled form;

FIG. 5 is a side view of the inside of one embodiment of a bollard according to the present disclosure in disassembled form;

FIG. 6 is a side view of an exemplary bollard according to the present disclosure in assembled form;

FIGS. 7-8 depict top isometric views of embodiments of bollards similar to that shown in FIG. 6; and

FIGS. 9-11 depict side views of the inside of further embodiments of bollards according to the present disclosure in disassembled form.

### DETAILED DISCLOSURE

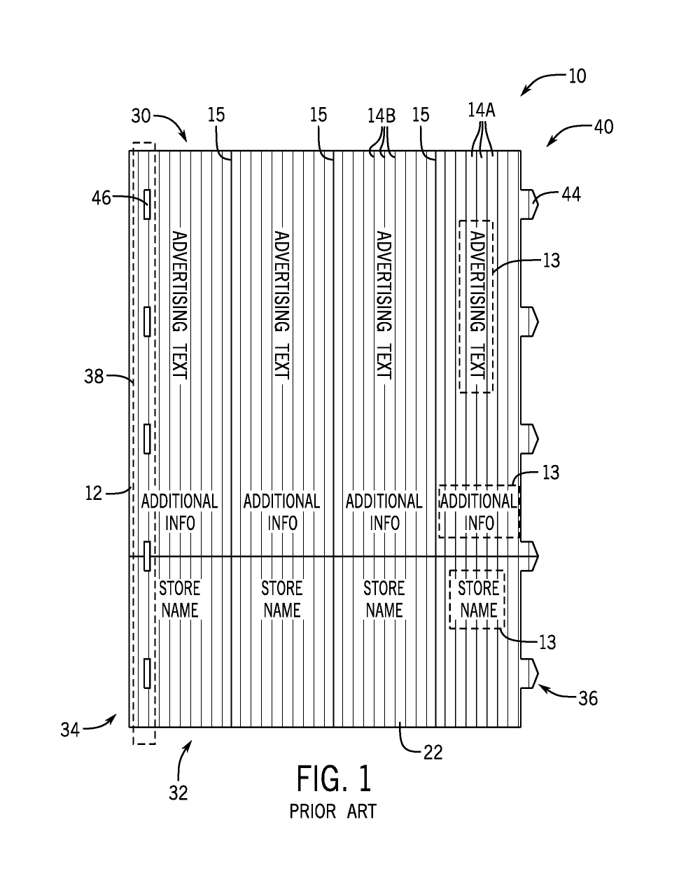

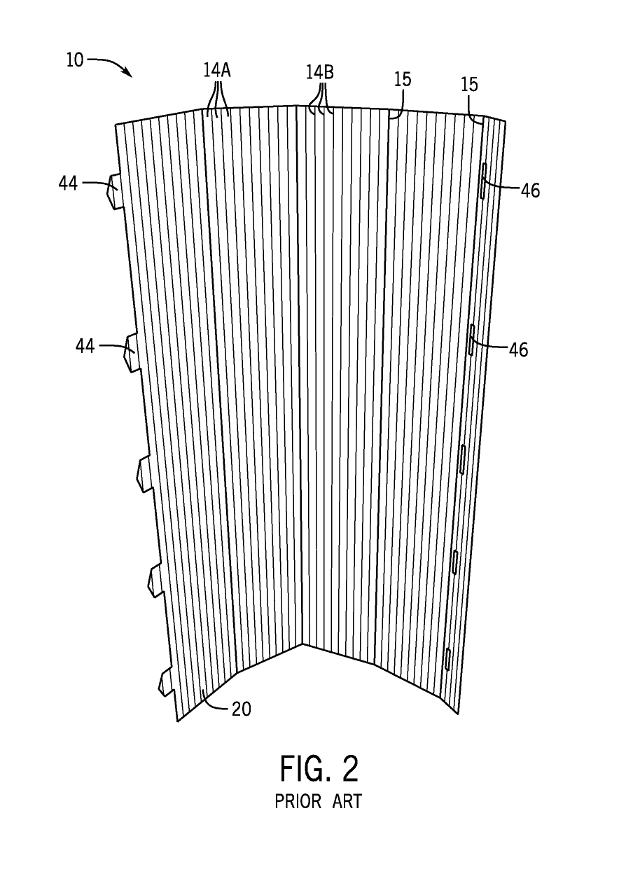

Although corrugated plastic sheets often are used for making bollards, the present inventors have identified corrugated plastic sheets have their limitations. For instance, the thickness of corrugated plastic sheets is limiting in that they can only be screen printed or digitally printed, which are lower resolution printing techniques. Specifically, corrugated plastic sheets are bulky, partially due to their corrugated flutes, which also results in higher shipping costs. Moreover, corrugated plastic sheets have limited eye appeal due to their rough corrugated plastic look, the exposed corrugated plastic edges when sheets are scored and folded, and the ribbed surface texture caused by their corrugated flutes. Examples of bollards currently manufactured and in use are illustrated in FIGS. 1-4. As such, the present inventors have identified that new materials and methods for preparing bollards are needed.

The bollards shown in FIGS. 1-4 as presently known in the art are constructed of a material 12, which as previously discussed is typically a corrugated plastic sheet having a thickness of ⅛″. As shown, this material 12 includes corrugation openings 14A defined between corrugation supports 14B in the manner known in the art. The material 12 has an inner surface 20, outer surface 22, and a thickness 24 therebetween. Evidence of the corrugation supports 14B is prevalent on both the inner surface 20 and outer surface 22, which the present inventors have identified to be unattractive consequences of methods and materials presently known in the art.

The material 12 further extends between a top 30 and a bottom 32, as well as between a fixed end 34 and a floating end 36. The floating end 36 is configured to be fixed relative to the fixed end 34 within a fixation region 38, such as by using a locking system 40 comprising taps 44 and slots 46 configured to receive the taps 44 therein. Text 13 and/or logos are often provided on the outer surface 22, but as previously described cannot be directly printed on the material 12 due to its thickness 24. Accordingly, such text 13 may be provided as a sticker, wrap, or other label configured to be coupled to the outer surface 22 of the bollard 10.

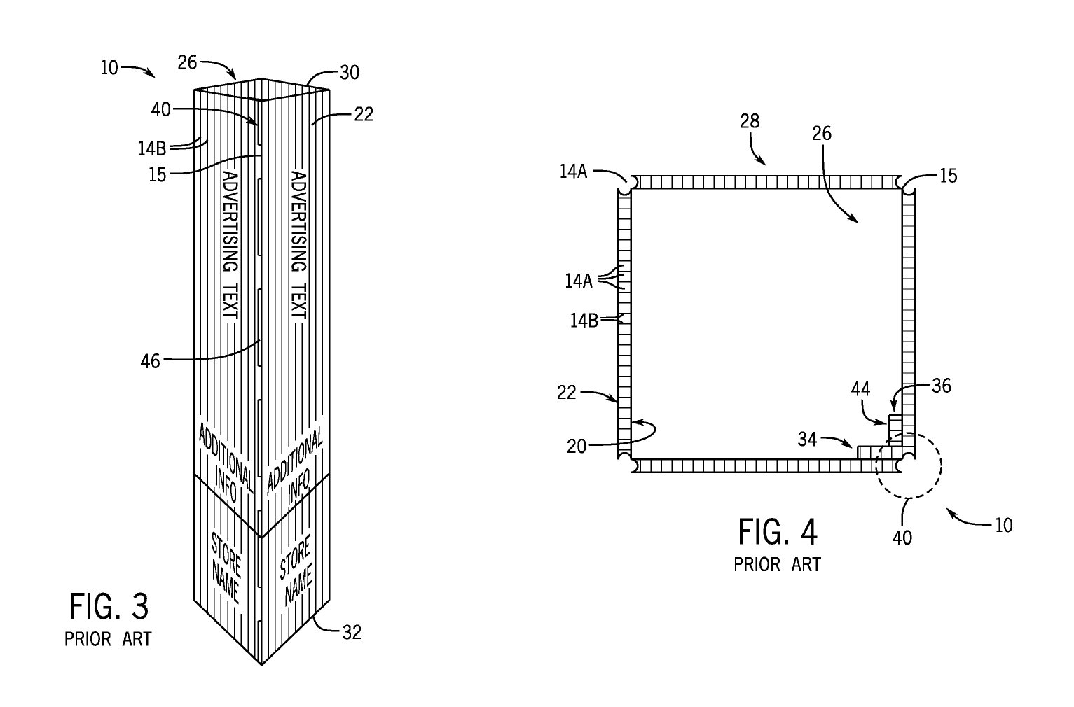

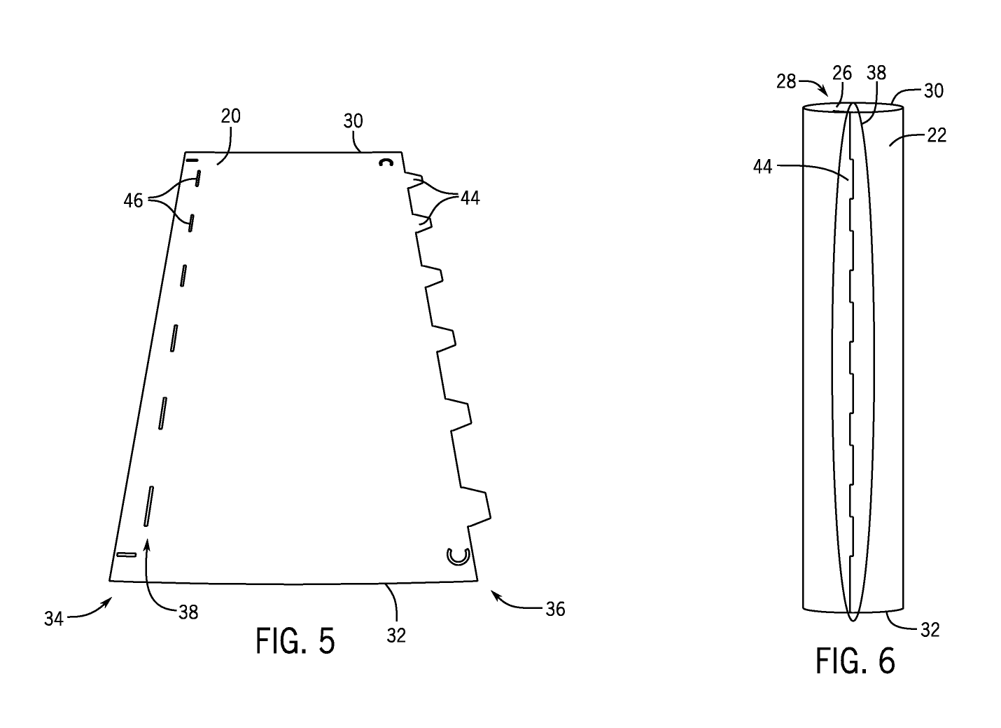

To assist in the process of folding the bollard 10 into an assembled configuration, creases 15 are provided between the top 30 and bottom 32 of the material 12. In this manner, the bollard 10 defines an internal surface area 26 of a corresponding cross-sectional shape 28 when the bollard 10 is in the assembled state, as shown in FIG. 3. In particular, the embodiment of FIG. 3 shows the bollard 10 having a squared cross-sectional shape 28 when assembled.

As shown in FIG. 4, the present inventors have identified that bollards 10 as known in the art suffer from sharp and/or visually unappealing corners when the bollard 10 is assembled, due to the corrugation openings 14A becoming exposed from the outer surface 22 when the material 12 is folded on the creases 15.

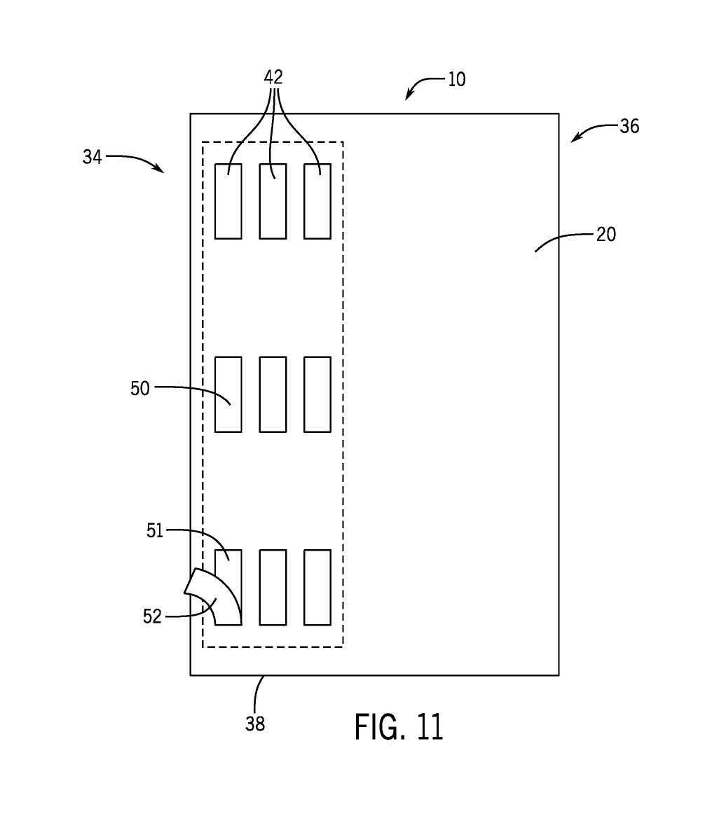

Accordingly, the present inventors have identified alternative methods and materials for creating bollards 10, as shown in FIGS. 6-11. In certain embodiments, these new materials 12 may include, but are not limited to, materials having a thickness of less than 0.125″, including about 0.010″, 0.015″, 0.020″, 0.025″, 0.030″, 0.040″ or other thicknesses. The present inventors have determined exemplary materials 12 to include a polyolefin material (e.g., ProPrint Plus™), or other variations of similar materials such as styrene material, polyvinyl chloride material, polypropylene material, polyethylene material, polycarbonate material, polyethylene terephthalate glycol-modified (PETG), amorphous polyethylene Terephthalate (APET), or the like, are useable as materials enabling this range of thicknesses, and thicknesses less than those presently known among bollards in the art more generally. In further embodiments, the selected material is outdoor weatherable and durable.

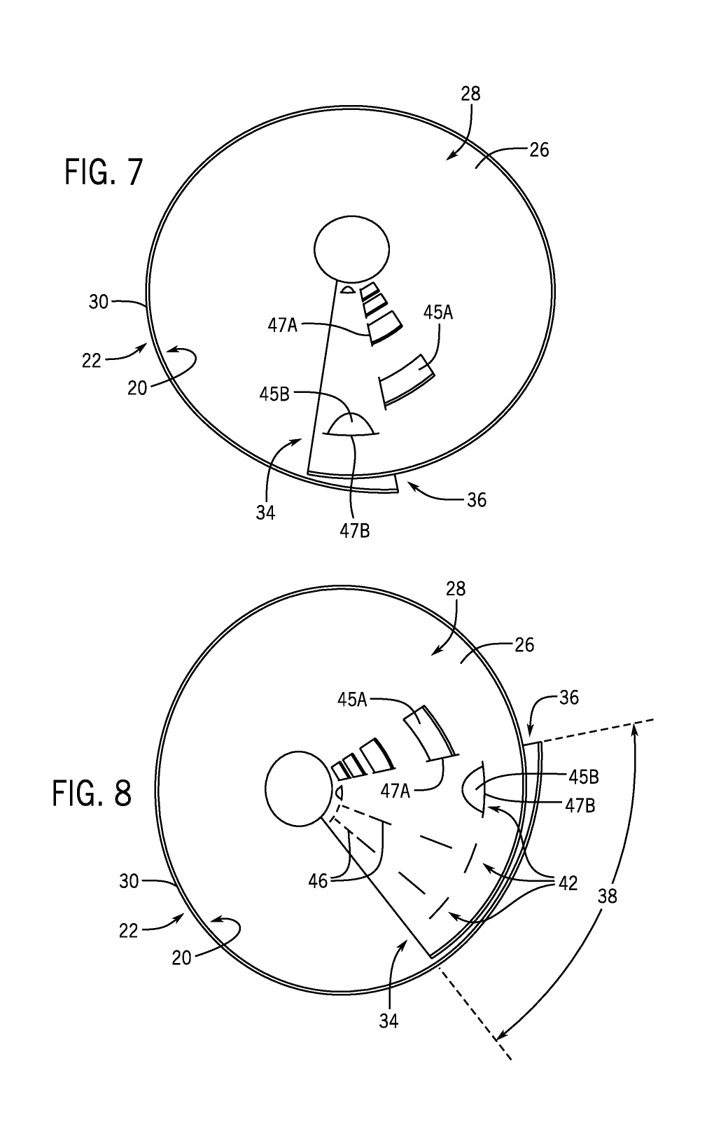

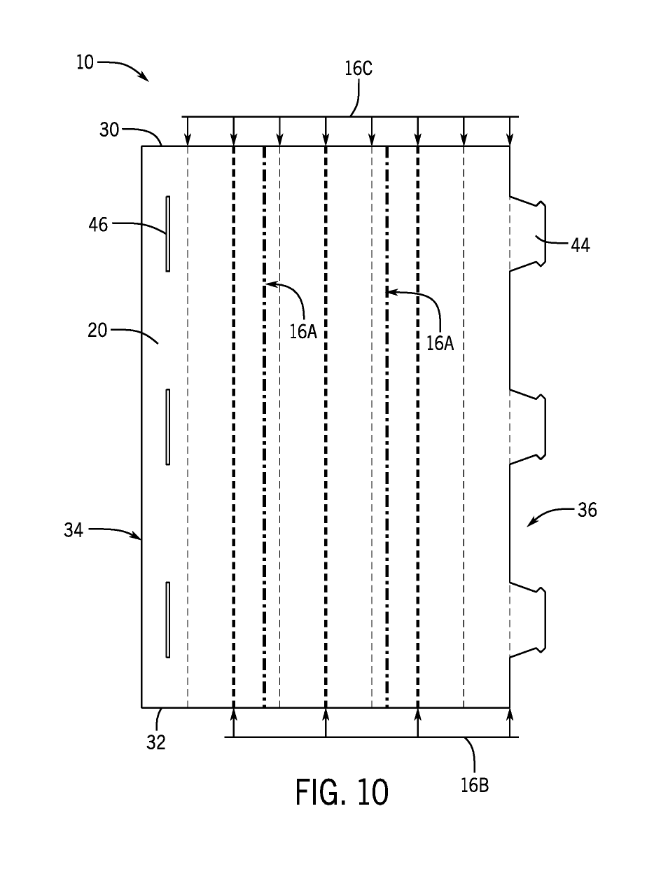

Certain embodiments of the disclosed bollards utilize a tab 44 (see FIG. 6) or double tab 445A, 45B (see FIG. 7) locking system 40 having corresponding slots 46 or double slots 47A, 47B. Suitable locking systems may include those known in the industry, such as Christmas tree clips, adhesives 50 (including a sticky side 51 and backing 52), push-pins, plastic gripper bars, hook and loop systems (e.g., Velcro® systems), Dual-Lock systems, hot glue, glue dots, and the like. In further embodiments, the locking system 40 includes a duality of locking positions 42 within the fixation region 38, which permits the bollard 10 to be assembled to be different sizes (having different internal surface areas 26) or cross-sectional shapes 28 depending upon the specific location within the plurality of locking positions 42 for engaging the locking system 40. For example, these include creases for a triangle configuration 16A, a square configuration 16B, or an octagonal configuration 16C, as shown in FIG. 10.

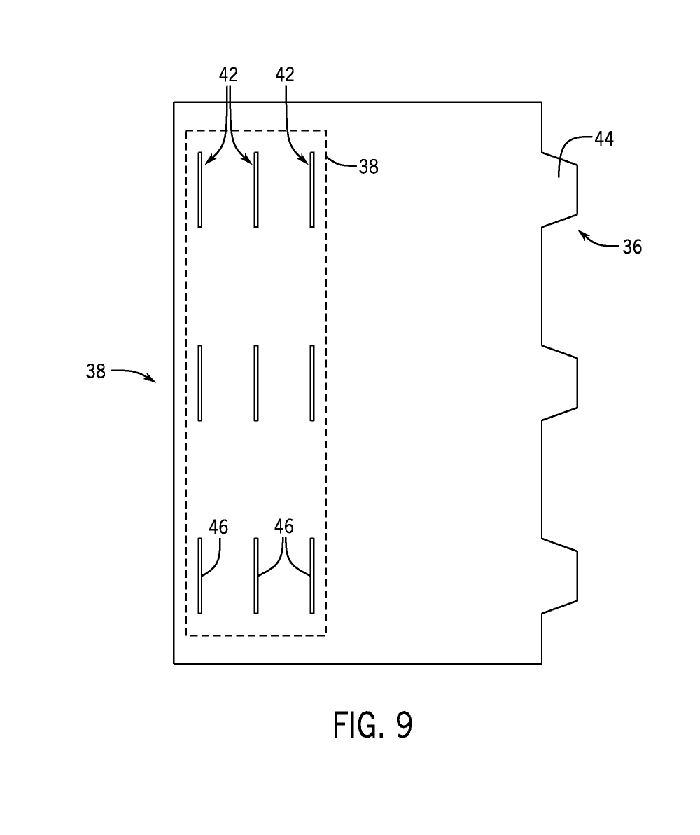

Exemplary embodiments providing a plurality of locking positions 42 are shown in FIGS. 8 and 9, whereby in the present example the same tabs 44 are engageable in one of three locking positions 42, each corresponding to a different internal surface area 26 and potentially a different cross-sectional shape 28 upon assembly of the bollard 10.

Some of the advantages of the disclosed new materials 12 for preparing bollards include, but are not limited to the following. These new materials 12 can be printing using not only using one screen printing and digital printing methods, but also with lithography. When printed using lithography, the bollard 10 has a higher resolution, providing much nicer, higher quality graphics, than conventional methods for making bollards 10 via screen printing or digital printing. In contrast to prior art methods and materials, this new material 12 may be utilized to prepare round bollards 10 with no noticeable creases 15 and having a smooth curved outer surface 22 for added eye appeal, as shown in FIG. 6. The presently disclosed materials further avoid the unsightly sharp corners or edges of prior art materials and methods used in making bollards 10, as these new materials 12 do not require corrugation. It should be recognized that in this respect, references to “folding” include rolling and other handling that positions the fixed end 34 nearer to the floating end 36 for assembly of the bollard 10.

Additionally, the bollards 10 prepared from the disclosed new materials 12 can be rolled and shipped in a tube if desired. Moreover, the new materials 12 can be made into bollards 10 having different cross-sectional shapes 28 by using scoring or creases 15. Additional scoring or creases 15 may also be incorporated to permit the bollard to be folded or assembled in different sizes, as previously discussed.

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention. Citations to a number of patent and non-patent references may be made herein. The cited references are incorporated by reference herein in their entireties. In the event that there is an inconsistency between a definition of a term in the specification as compared to a definition of the term in a cited reference, the term should be interpreted based on the definition in the specification.

We claim:

1. A bollard, the bollard comprising:
a material having a thickness of less than 0.125″, wherein the material has a fixed end, a floating end opposite the fixed end, and a fixation region defined therebetween; and
a locking system for retaining the floating end of the material adjacent to the fixation region;
wherein the bollard is configured to be assembled by folding the material such that the floating end is adjacent to the fixation region and engaging the locking system to retain the floating end adjacent to the fixation region.

2. The bollard of claim 1, wherein the material is non-corrugated and the thickness is no more than 0.040″.

3. The bollard of claim 1, wherein the material comprises one of polyolefin, styrene, polyvinyl chloride, polypropylene, polyethylene, polycarbonate, polyethylene terephthalate glycol-modified (PETG), and amorphous polyethylene Terephthalate (APET).

4. The bollard of claim 3, wherein the fixation region is closer to the fixed end than to the floating end.

5. The bollard of claim 3, wherein the locking system includes a plurality of locking positions for the floating end to be retained, wherein bollard defines an internal surface area when assembled, and wherein the internal surface area varies depending upon which of the plurality of locking positions the floating end is retained in.

6. The bollard of claim 5, wherein the bollard further defines a cross-sectional shape when assembled, and wherein the cross-sectional shape is different when the floating end is retained in at least two of the plurality of locking positions.

7. The bollard of claim 6, further comprising creases within the material that bias the bollard into a particular shape among the different cross-sectional shapes when the floating end is retained in a particular position of the plurality of locking positions.

8. The bollard of claim 6, wherein one of the cross-sectional shapes is a triangle.

9. The bollard of claim 3, wherein the locking system comprises tabs and slots configured to receive the tabs, and wherein the floating end is retained adjacent to the fixation region when the tabs are received within the slots.

10. The bollard of claim 1, wherein the material is configured to be printed via lithography.

11. A method for making a bollard, the method comprising:
obtaining a material having a thickness of less than 0.125″, wherein the material has a fixed end, a floating end opposite the fixed end, and a fixation region defined therebetween, and wherein the material is non-corrugated; and
incorporating a locking system for retaining the floating end of the material adjacent to the fixation region;
wherein the bollard is configured to be assembled by folding the material such that the floating end is adjacent to the fixation region and engaging the locking system to retain the floating end adjacent to the fixation region.

12. The method of claim 11, wherein the material comprises one of polyolefin, styrene, polyvinyl chloride, polypropylene, polyethylene, polycarbonate, polyethylene terephthalate glycol-modified (PETG), and amorphous polyethylene Terephthalate (APET).

13. The method of claim 11, wherein the fixation region is closer to the fixed end than to the floating end.

14. The method of claim 11, wherein the locking system includes a plurality of locking positions for the floating end to be retained, wherein bollard defines an internal surface area when assembled, and wherein the internal surface area varies depending upon which of the plurality of locking positions the floating end is retained in.

15. The method of claim 11, wherein the bollard further defines a cross-sectional shape when assembled, and wherein the cross-sectional shape is different when the floating end is retained in at least two of the plurality of locking positions.

16. The method of claim 15, further comprising creasing material such that the bollard is biased into a particular shape among the different cross-sectional shapes when the floating end is retained in a particular position of the plurality of locking positions.

17. The method of claim 15, wherein one of the cross-sectional shapes is a triangle.

18. The method claim 11, wherein the locking system comprises tabs and slots configured to receive the tabs, and wherein the floating end is retained adjacent to the fixation region when the tabs are received within the slots.

19. The method of claim 11, further comprising printing the material via lithography.

20. The method of claim 11, wherein the material is non-corrugated and the thickness is no more than 0.040″.
